(19) United States
(12) Patent Application Publication
(10) Pub. No.: US 2023/0339332 A1
(43) Pub. Date: Oct. 26, 2023

(54) Wind based electrical generation system for vehicles

(71) Applicants: Charles L Maury, Mesa, AZ (US); Armando Ramirez, Phoenix, AZ (US); Matthew Woolgar, Mesa, AZ (US); Damon Gonzalez, Queen Creek, AZ (US)

(72) Inventors: Charles L Maury, Mesa, AZ (US); Armando Ramirez, Phoenix, AZ (US); Matthew Woolgar, Mesa, AZ (US); Damon Gonzalez, Queen Creek, AZ (US)

(73) Assignee: Zero Electric Vehicles Corp., Gilbert, AZ (US)

(21) Appl. No.: 17/803,286

(22) Filed: Apr. 20, 2022

(51) Int. Cl. B60L 8/00; F03D 9/32; F03D 17/00

(52) U.S. Cl. CPC B60L 8/006; F03D 9/32; F03D 17/00; F05B 2260/84

(57) ABSTRACT

The present invention relates to wind-based generation of electrical energy. By providing small individual generation units that can be combined to have inputs at one or more wind pressure peak areas on a vehicle and outlets at low pressure locations on a vehicle, it is possible to contribute substantial amounts of wind-generated electricity for powering the vehicle without creating equivalent offsetting aerodynamic drag.

### RELATED APPLICATION

This application claims priority on commonly owned and previously filed U.S. Provisional Patent Application No. 62/924,926, filed Oct. 19, 2019. The entire disclosure of U.S. Provisional Patent Application No. 62/924,926, filed Oct. 19, 2019, is hereby incorporated by reference. This application further claims the benefit of priority based on the commonly owned and previously filed U.S. Nonprovisional patent application Ser. No. 16/873,963, filed Aug. 29, 2020, the entire disclosure of which is hereby incorporated by reference.

### FIELD OF THE INVENTION

The present invention relates generally to the field of electrical power generation. More specifically, the invention relates to improving the recapture of energy lost to aerodynamic drag during operation of a vehicle.

### BACKGROUND OF THE INVENTION

There have been many prior approaches to capturing energy associated with moving motor vehicles, but thus far, improvements have continued without approaching any theoretically optimized solution. Examples of prior approaches directed to the capture of energy associated with moving vehicles are dominated by systems having roof mounted fans exposed to the air passing over the roof. These systems all suffer from the fact that they add extra aerodynamic drag to the vehicle due to their frontal surface area being exposed to the flow of air. Examples of other systems for recovering some of the energy otherwise lost to aerodynamic drag include the following.

U.S. Pat. No. 10,669,992, dated Jun. 2, 2020, “Wind power collection and electricity generation system” describes a technique for collecting the wind energy created by moving motor vehicles. This patent recognizes that energy is available as a result of the movement of a vehicle through the air but directs the collected energy to a central location instead of making the captured energy available to the individual driven vehicle. Thus, the captured energy is not useful for the driven vehicle, such as for extending the range of a vehicle being driven.

U.S. Pat. No. 10,533,536, dated Jan. 14, 2020, “Wind power generating device installed in a vehicle” describes a wind power arrangement installed on a vehicle and intended to provide a continuing supply of electrical energy, even when the vehicle is not moving.

U.S. Pat. No. 10,479,197, dated Nov. 19, 2019, “Wind powered system for vehicles” discloses another wind powered system which includes “a plurality of wind tunnels, a plurality of rotary fans provided in each wind tunnel, a plurality of alternators connected to the plurality of rotary fans to generate electricity, a transformer connected to the plurality of alternators, electric components connected to the transformer, and a battery connected to the transformer and the electric components. The transformer is supplied with the electricity generated by the alternators and outputs electrical energy with a voltage to be supplied to at least one of the electric components and the battery. The plurality of wind tunnels have a plurality of intake inlets which are separated and apart from each other and a single outlet shared by the plurality of wind tunnels.”

U.S. Pat. No. 10,173,663, dated Jan. 8, 2019, “Total electric vehicle”, discloses a system wherein an electric vehicle receives propulsion power from “two sources of static, stored, electric power and three sources of Dynamic, generated electric power. The two stored sources are a Battery and a supercapacitor system. The three sources of Dynamic power are: (1) Regenerative power in both the braking, deceleration phase of travel, the downward slope of travel over some extended distance, and part of cruise control; (2) Power from a modified Squirrel Cage generator; and (3) Power through the solar silicon panels. The Static and Dynamic powers are fed into the current Consolidator, Distributer, and Controller (CDC) systems to provide electric power to the drive motors. The total distance travelled is the sum of the Static, stored power plus the generated power of the Dynamic system.”

Still, even with all the work that has been done, it has been recognized that further improvements are necessary. This is made clear in U.S. Pat. No. 10,072,641, dated Sep. 11, 2018, “Apparatus for generating energy from a fluid flow induced movement of a surface structure relative to an opening to a cavity in a frame” that discloses another approach to capturing wind energy in a moving vehicle. This disclosure identifies limitations in the prior art, stating, for instance, that “Generators harnessing energy from a fluid flow (such as air) are known within the art, however such generators typically have turbines or propellers which have a large cross-section. The movement of the medium creates a motive force upon the turbine or propeller, which is connected to a device to convert the movement into electricity. But the large cross-sections of these traditional designs increase the amount of wind resistance presented by the generators, limiting the practicality of their application in certain fields.” This patent further states, “There is a need for a device that can generate electricity from relatively lower levels of motive force and provide smaller cross-sections. There is also a need for scalable, stackable devices to generate electricity in locations where traditional devices are not suitable. The increased use of electric and hybrid engine systems in vehicles has also created an increased need for ways of generating electricity to recharge batteries.”

In other instances of capture of wind energy for electrical power generation, it is ordinary practice to place a windmill, to the extent possible, away from any interfering structures. Thus, windmill farms are placed in wide open spaces, such as flat fields or offshore, where there is no interruption of the incoming wind flow. Similarly, even for sailboats, it is common to place a windmill-type structure on a separate mast.

### BRIEF SUMMARY OF THE INVENTION

According to the invention, energy from the apparent wind can be harnessed in a moving vehicle in an efficient manner relative to pre-existing approaches. This is accomplished by providing a system in which wind powered generation devices are positioned at locations on the vehicle where there is high air pressure resulting, for the most part, from forward facing portions of the vehicle impacting the air as the vehicle progresses. At these locations, wind energy is concentrated and can be captured efficiently by a wind-based generator while at the same time avoiding the creation of significant incremental aerodynamic drag in the vehicle. By directing this energy to the onboard vehicle energy requirements there is a net improvement in the vehicle's travel range. The invention has great utility in electric and hybrid vehicles, extending the range significantly. These high pressure areas have high potential energy relative to areas where the wind flows more efficiently along the vehicle surfaces. Identification of these areas can be accomplished according to the invention and the wind-based generators can be strategically placed to take advantage of aerodynamic inefficiencies associated with vehicle design. The invention is particularly adapted for improving the power efficiency of existing vehicles by retrofitting the power generation devices into existing vehicles and thereby improving the vehicle range.

It is an object of the present invention to improve the range of a vehicle by recapturing some of the energy otherwise lost to aerodynamic drag.

It is another object of the present invention to capture the greatest amount of wind energy possible relative to the amount of wind resistance added to a moving vehicle on which the wind generation system is mounted. In this manner, the system captures energy that would otherwise be wasted.

It is another object of the present invention to provide a wind generation system that can be used in a variety of vehicle applications without unnecessarily increasing the aerodynamic drag of the vehicle, and in which any increases in aerodynamic drag are more than offset by the energy generated by the system.

These and other objectives of the invention are accomplished through a combination of highly efficient device design and highly sophisticated analysis of the overall vehicle arrangement. These design and analysis components of the implementations of the invention call for identifying specific areas on the vehicle where wind forces are relatively high, yet where the forces can be harnessed without creating an undesirable offsetting incremental counterforce. In motor vehicles any added drag to the vehicles aerodynamic performance is important, particularly in electrically powered vehicles where vehicle range is of major commercial importance. Thus, the invention facilitates capture of the wind forces for electrical power generation without adding an incremental equal and opposite reaction. This is done by locating regions of the vehicle structure where wind forces already impede the forward movement of the vehicle through the air and harnessing a substantial portion of the existing energy loss for electrical power generation. Importantly, the invention also calls for the avoidance of placing wind energy recapture devices at locations where the incremental aerodynamic drag exceeds the energy that can be recaptured. These advantages are further enhanced by placing the outlets of the energy recapture devices at locations on the vehicle where there is low pressure, contributing to the overall energy recapture by utilizing the highest possible pressure differentials between device input and device output.

### BRIEF DESCRIPTION OF THE DRAWINGS

FIG. 1 is a perspective view from the air inlet side of a wind generation system according to a preferred embodiment of the invention.

FIG. 2 is a perspective view of the gear and belt arrangement of a preferred embodiment of the invention.

FIG. 3 is an illustration of an assembled implementation of a single-channel implementation of the invention.

FIG. 4 shows an impeller blade and cone structure for use in a preferred implementation of the invention.

FIG. 5 shows additional details of the impeller with its blade structure suitable for implementation of the invention.

FIG. 6 is an illustration of an embodiment of the invention having four air inlets aligned in a row.

FIG. 7 is an illustration of an embodiment of the invention viewed from the air inlet side of a wind generation system showing the positioning of the impeller blades in the air channel.

FIG. 8 is an illustration of a vehicle having a forward-facing body portion suitable for implementation of the invention.

FIG. 9 is an illustration of an air channel for use in a preferred embodiment of the invention.

FIG. 10 illustrates an array of inlets for a multi-turbine implementation of the invention.

FIG. 11 illustrates a vehicle embodying low pressure areas suitable for placement of outlets from the turbines in accordance with a preferred implementation of the invention.

### DETAILED DESCRIPTION OF THE INVENTION

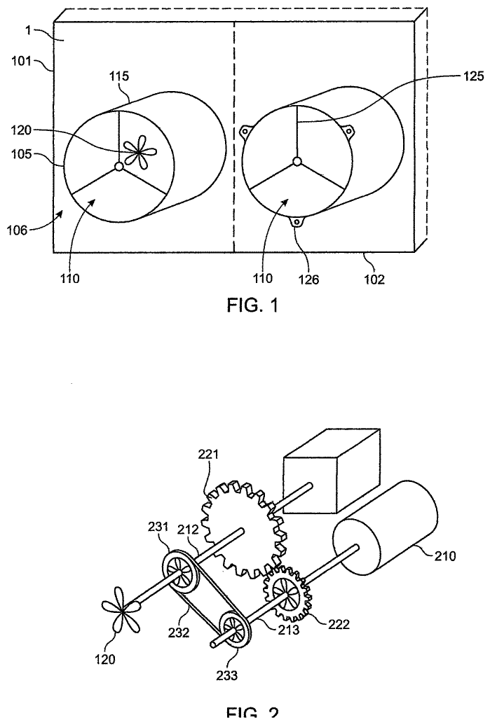

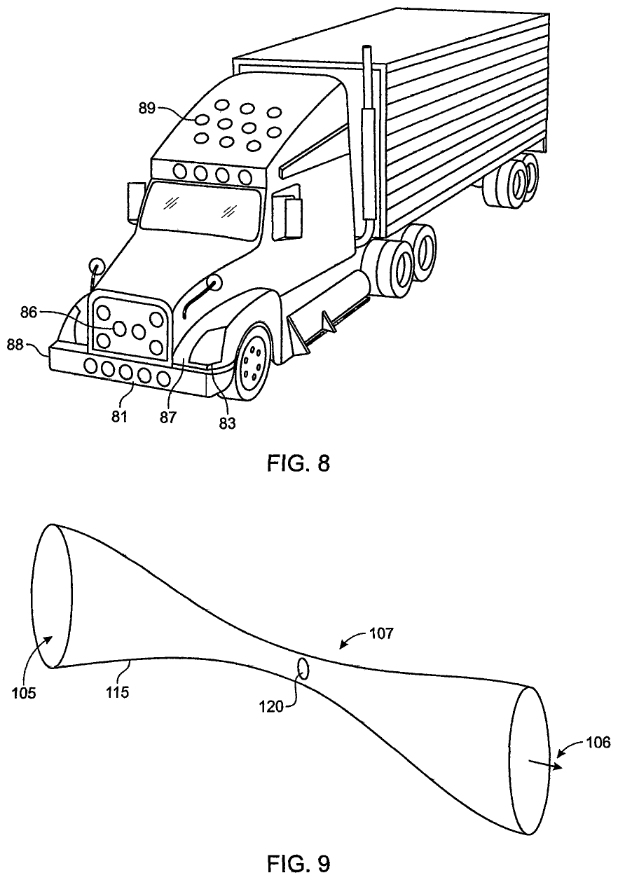

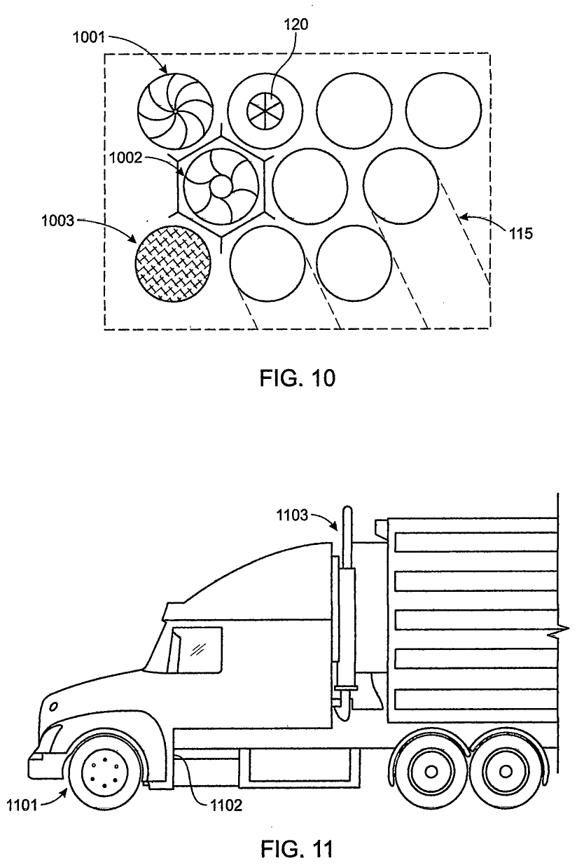

Referring to FIG. 1, the energy capture device 1 includes a housing section 101 for a first unit of the modular design and a second housing section 102 for the second unit of the modular design. Within each housing section is an input air channel 110 defined by a wind channeling structure 115. The input air channel extends from an air inlet 105 at the forward face 106 of the housing and extends toward the rear (not shown) of the wind channeling structure 115. Each housing section also has an impeller 120 (sometimes referred to herein as the blades) centrally and coaxially located for rotation in response to an incoming airflow via the air inlet of the air channel. The wind channeling structure 115 preferably has a cone shaped entrance with the wide end of the cone facing the air inlet end of the input air channel. In a preferred embodiment, the wide end of the cone is approximately 5 inches in diameter and the length of the cone is approximately 6 inches. The exit end of the cone 106 (shown in FIG. 9) has a diameter of approximately 3½ inches and in operation, this creates a venturi region 107 within the wind channeling structure. A front frame member 125 provides structural support for the wind channeling cone and helps to secure the cone to the housing, optionally through use of mounting tabs 126. The interior surface of the cone can include a number of profile ridges 71 (shown in FIG. 7) to aid in directing the incoming airflow to impart maximum rotational forces to the blades 120. The housing is of lightweight, weatherproof material, preferably impact resistant plastic of the type typically used for automotive components such as bumper covers or radiator fan shrouds, or the like. This unit will be exposed to incoming winds and is preferably constructed so it can withstand both extended periods of direct sunshine as well as frequent rainy weather. As mentioned, a plastic material of the type used for automotive bumper covers would be suitable and providing a protective covering for the material with automotive grade paint and sealants is desirable. Also, in situations where the unit is to be prominently visible, the selection of materials can become a design feature making it desirable to use a chrome finish or to provide either a color match to the vehicle finish or a coordinated or contrasting color. In addition to the appearance of the vehicle, it is desirable to protect the inlets from foreign objects and thus, FIG. 10 shows a mesh covering 1003 for covering the inlet. While this mesh cover is illustrated for only one inlet, it can be provided for all.

The electrical components of the wind-driven electric generator are shown in FIG. 2 where the input shaft 212 is rotationally driven by blade 120 and is the source of input energy to drive generator 210. Gears 221 and 222 transfer the rotational motion from the input shaft 212 to generator shaft 213.

In an automotive application, a one speed gear box can be employed in order to keep dimensions to a minimum within the vehicle embodying the invention. In other implementations it will be feasible to use a direct drive system. In a preferred embodiment, a tensioning pulley arrangement is provided having a first pulley 231 attached to the drive axel, a generator pulley 233 attached to the generator axel and a tensioning belt 232 engaging both pulleys 232 and 233. This pulley system has two specific functions: number one is to negate the centrifugal force of the aluminum shafts and to prevent any rotation requiring realignment during maintenance. Another is so the pulley can absorb such tensions usually absorbed by the drive shaft that produce heat due to metal on metal contact at bushings and bearings making this implementation of the invention 10-13 percent more efficient than systems without the pulley system at temps ranging above 20 degrees Celsius. The single speed gearbox system provides more output power but also requires higher speeds to work at its optimized voltage and current requirements. These gears are sized according to spec, in terms of overall diameter dependent on depth and height of corresponding vehicle design space. For a multispeed gearbox, a second gear (not shown) could be placed adjacent to the single gear 222 shown in FIG. 2 and a tensioning pulley could be provided between pulleys 231 and 233 to maintain the desired engagement of the gears.

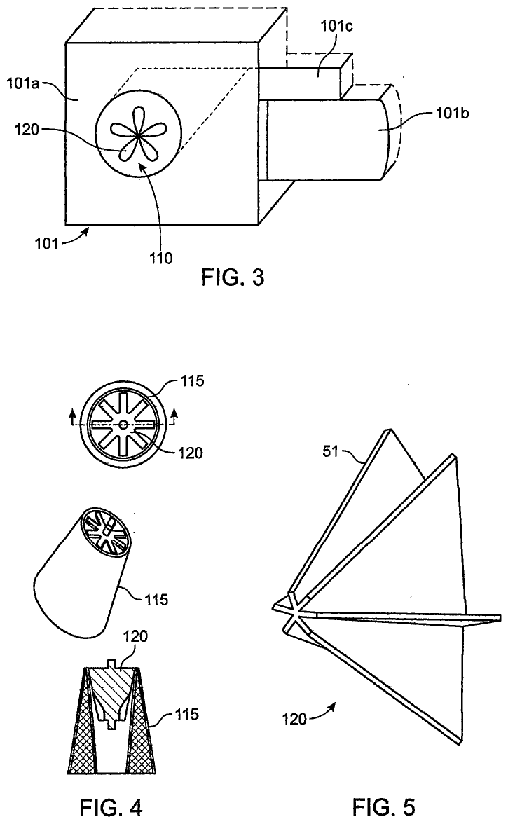

With reference to FIG. 3, a single channel module is shown within a finished housing 101. Housing section 101a contains the entrance to the airflow channel and related components (the impeller and drive axel) while housing section 101b contains the generator. Housing section 101c contains the gears and pulleys for transferring rotational motion from the input shaft 212 to the generator drive shaft 213.

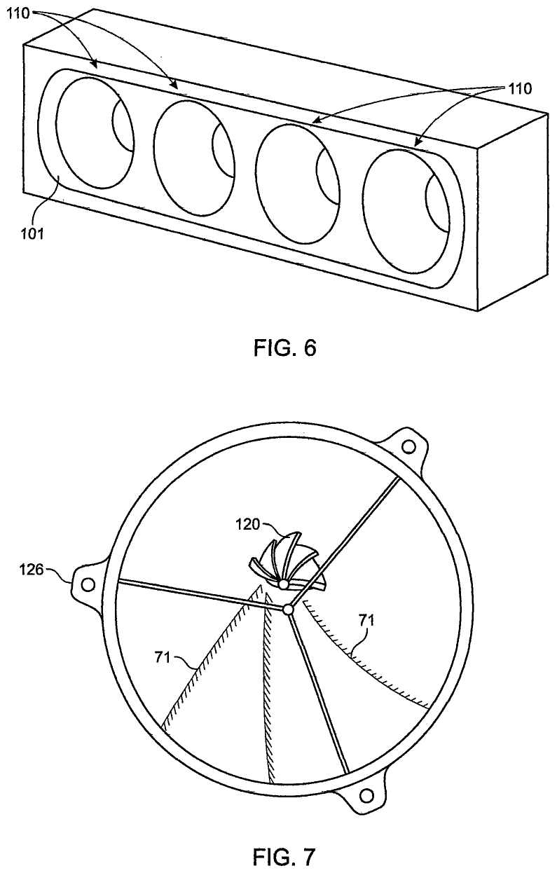

The blades 120 and cone 115 structures are shown in FIG. 4 where the tapered cone is shown surrounding the centrally located impeller 120. Further design features of the blades 120 are shown in FIG. 5. While it is feasible to have 4 or more blades for the impeller in order to generate electricity, it has been found that using 8 (6 are illustrated) or more blades on the impeller consistently provides the desired level of efficiency for meeting the objectives of the invention. The blades define a conical profile to generally align with the interior surface of cone 120 and are angled to provide the desired rotational drive for input shaft 212. Selection of the desired angle of the blades on the impeller can be determined as a function of the system design, particularly the input wind velocity for which the system is being optimized. Thus, for applications where the system is to be used for over the road trucking, the system can be optimized for winds in the range of typical highway driving speeds.

The length of the impeller is also to be selected as a function of the speed of the incoming airflow as with the angle of the blades. The weaker the incoming airspeed, the longer the impeller should be to develop the torque needed for effective power generation. For incoming airflow speeds averaging less than 20 mph an impeller having a length of at least 3 inches (measured along the axis of the drive shaft) should be selected and the angle of the edge 51 of the blades relative to the axis of the drive shaft should be between about 40 degrees and 50 degrees.

In order to locate the system for optimum performance on a motor vehicle, it is desirable to custom design both the vehicle and the system. FIG. 6 illustrates a housing for a 4-channel system having 4 inlets 110 arranged within a single housing 101 that is optimized for location on the front bumper of a vehicle designed for operation on highways. FIG. 8 shows the front of a typical over the road vehicle. The bumper-mounted straight line of 4 or more air input channels in module 81 is compatible with the forward-facing bumper 88 (or bumper cover) of the vehicle. The length of the multi-channel unit is less than the span across the front of the bumper and the height of the module 81 is less than the height of the bumper. The frontal surface of the forward-facing bumper of a motor vehicle is a wind pressure peak area, that being a section of the vehicle where wind directly impinges on the surface when the vehicle is underway. As a result of the forward-facing nature of a front bumper, the full surface area of the bumper is subjected to high wind resistance and thus is a source of significant aerodynamic drag, particularly at higher speeds such as highway speeds. There are numerous other vehicle surfaces that are wind pressure peak areas, including the front grill 86, forward facing areas around headlights 87 and along the front of fenders 83, and even air deflectors 89 on the top of the cab on over the road trucks. Each of these wind pressure peak areas is a suitable area for installation of a wind generator system in accordance with the present invention. The selection of these wind pressure peak areas has the advantage of providing electrical power that exceeds the power required for any incremental aerodynamic drag introduced by the system. As a result, there is a met power gain provided by the system. In applications where the system is optimized, substantially the entire power output of the generator system is added to the vehicle reserves without taking away (or otherwise utilizing) equivalent power from any other vehicle power requirements. The wind energy that is used for power generation would have otherwise been entirely (or nearly so) lost to aerodynamic drag. To fit the housing of the present system to specific vehicle applications, there will be situations where the front bumper of a vehicle has a curve. The housing of the generator system can be contoured to match the vehicle curves along both vertical and horizontal directions and can even be designed for alignment along a diagonal member of the vehicle. With this design flexibility, a housing for multiple wind channels can be advantageously employed to capture otherwise-lost wind energy from numerous wind pressure peak areas as well as from wind pressure peak areas having complex shapes or unusual orientations on the vehicle, such as the areas 83 and 87 beside the headlights of the vehicle in FIG. 8.

An incremental improvement in efficiency can be achieved by situating the outlet of the wind generation unit at a low pressure area of the vehicle. Generally, this might be along the forward inner surface of the wheel well 1101 in FIG. 11, or along the rear bumper, or bumper cover. In an aerodynamically efficient over-the-road truck, there may be a low pressure area at the trailing edge 1103 of an air deflector. Locating the inlet at a high pressure area and the outlet at a low pressure area provides improved performance of the turbine due to the enhanced pressure drop across the device, thus supporting greater airflow through the turbine. Identification of a low pressure area on any vehicle might involve actual pressure testing, or simply intuitive evaluation of the vehicle design. For instance, there may be low pressure areas adjacent the trailing edge 1102 of a front fender in some vehicle designs while another vehicle with a different aerodynamic design may have a pressure-neutral region adjacent the front fenders. Efforts to optimize aerodynamics in electric vehicles are quite advanced and it will be well known to or determined without undue effort by vehicle designers where high pressure and low pressure regions exist on any particular vehicle.

Although not shown in the drawings, many other vehicles have wind pressure peak areas that are well suited for utilization of the present invention. For instance, wind driven vehicles such as sailboats often employ a wind powered generator. These systems typically rely on a windmill-type generator sifting atop a pole near the stern of the boat. Unfortunately, while such a system does indeed generate electricity, the physical structure of the system directly interferes with the sailing efficiency of the boat. The entire windmill is exposed to the wind and directly creates aerodynamic drag opposed to any attempt to make headway into the wind. The present invention can generate electricity from the wind without interfering with forward progress. To accomplish this, the wind generation system is installed along a portion of the dodger where the dodger is already blocking the wind. The inventive system can be installed without creating any incremental wind resistance, avoiding the disadvantages of prior sailboat wind generators. Power boats can also benefit from the invention. The range of a powerboat is a direct function of the fuel capacity and the fuel burn rate per mile. Adding the invention's system to a powerboat reduces the amount of fuel needed to recharge batteries and operate vessel accessories thus reducing power requirements from the fuel and increasing the miles per gallon. As a result, the boat will be able to make longer voyages when the inventive system is employed than would otherwise be possible.

A preferred embodiment of the invention includes four inlets and is constructed as a modular unit. This design consists of four 5-inch diameter inlet tubes for the main housing and a separate 3-inch diameter housing associated with each inlet for the respective gears and motor. A turbine is housed in each of the four main tunnels while the battery, gears and motor are located in the separate side chambers. Details of the design include inlet tubes having a 5-inch diameter and enclosing the turbine and drive axel for each tube. There is a 12V and/or 24V motor (low internal resistance with forward/reverse gear set) along with 2 gears of thermoset plastic and a safety pulley arrangement. An air flow sensor is also provided for each tunnel. The pertinent design considerations are:

$$P = {I}^{2} R , I = P / E , R = \frac{P}{{I}^{2}} , V = P / I$$

$$Pulley Tension = T = ( \frac{2 {m}_{1} + {m}_{2}}{{m}_{1} + {m}_{2}} ) * g where {m}_{1} and {m}_{2} are the mass of the two pulleys$$

$$Centrifugal Force = {P}_{C} = {m}_{1} {v}^{2} or {P}_{C} = {M}^{′} {r}^{2} {w}^{2}$$

$$Pulley Diameter = d = {( 1200 - 150 )}^{3} \sqrt{\frac{p}{{n}_{1}}} = \sum d = iD$$

$${T}_{C} Pulley = {T}_{R} Pulley , \frac{{P}_{1} - {P}_{2}}{{P}_{2} - {P}_{1}} = {e}^{μ∅}$$

$${V}_{1} = {w}_{1} r , {V}_{1} = 2 {V}_{2} , {W}_{w} * {r}_{1} = {W}_{w} * {r}_{2} ; \frac{{V}_{w}}{{r}_{w}} ( \frac{60}{211} * {r}_{1} ) = {w}_{m} * {r}_{2}$$

$$\frac{{d}_{1}}{{v}_{2}} = gear ratio$$

The theoretical voltage, current, and power values based on compressed air testing provided an output of V=26 volts and I=20 mA with a resultant power generation of P=2.1 kWh as the power regenerated towards the battery back during 1 hour of drive time. This is based on highway simulation of a velocity at

$$60 mph = 26.8 m / s {w}_{c} * \frac{2 π}{60} * {r}_{w}$$

$${r}_{1} = 5 , {r}_{2} = 5$$

$${v}_{1} = 26.8 m / s = {w}_{1} * 0.1 = 216 , {w}_{2} * 0.05 = 272$$

$$Max = \frac{( {T}_{S} + {c}^{11} )}{2} * \frac{( {w}_{{w}_{0}} - {l}_{max} )}{2}$$

$${P}_{max} = {F}_{net} * {V}_{a ν g} * \frac{60}{2 π}$$

$$Gear ratio : 1 : 10$$

The theoretical Power generated at these conditions under pressurized air testing: resulted in:

Pₘₐₓ=2.1 kW per hour travelling at 60 mph or 26.8 m/s

Test Results for this quad system: (all results dependent on high voltage harness, maximizing current within a vehicles HVAC or battery tray system, at different voltage outputs depending on gear ratio)

Power Output:

12V @ 1500 RPM=1.2 kWatts instantaneously

24V @ 1500 RPM=2.4 kWatts instantaneously

12V @ 1500 RPM Average Trip Distance=1250 Miles; Average mph=67.5 mph (Highway Speeds); Average Time 18.52 hours, 1,111.2 minutes, 66,672 seconds

Power Generated=14,667.8 Watts-hours or 14.7 kWh 24V @ 1500 RPM Average Trip Distance=1250 Miles; Average mph=67.5 mph (Highway Speeds); Average Time 18.52 hours, 1,111.2 minutes, 66,672 seconds Power Generated=34,669.44 Wh or 34.7 kWh

RPM Average of 1500RPM for all testing wattage,

5,000 Watts of Power needed to run HVAC system within truck cabin (Average 9 hour run time) 45 kWh total requirement

3,000 Watts of Power needed to run Heater within truck cabin (Average 9 hour run time) 27,000 kWh total requirement

Average 1250-mile route will generate enough energy to operate the HVAC system for 2.9336 hours: 12V Motor

Average 1250-mile route will generate enough energy to operate the HVAC for 6.9339 hours: 24V Motor

Average 1250-mile route will generate 4.8893 hours of Heater run times: 12V

Average 1250-mile route will generate 11.55648 hours of Heater run times: 24V

Electric Semi Truck Platform: Around 200kWh 620-mile range

3,220 (Watt-Hours per mile traveled) to generate 1.04 miles of range per 62.0 miles at highway speeds

Energy Generated per Single Battery Charge: 60 miles added per 150 kWh battery pack (10.19% increase)

In a general sense, the implementation of the invention can involve an electrical generation system employing multi-serried or parallel turbine modules comprising blades which harness air to use as a catalyst for rotating a shaft attached to a gear set which ultimately generates power through a generator that can be directed by an on-board regenerative ECU towards battery cells, a vehicle inverter, or to a separate power management system, wherein said power is sufficient to cover the vehicle's parasitic overhead and to power an on-board management system. A turbine module, as used herein, means a wind driven electrical power generator employing at least one rotating blade or set of blades constructed to have a housing with a lower edge and an upper edge. When multiple turbine modules are employed, a single housing can be employed for the plurality of turbine modules. For convenience, turbine modules may be referred to herein simply as turbines. In operation, there is an inlet end through which high pressure (forced air) enters the turbine and then an outlet end through which air exits the turbine. Having a greater pressure differential from inlet to outlet provides greater opportunity for electrical generation, largely because there will be more airflow through any given structure when the pressure differential is greater.

In a preferred embodiment, an electrical generation system having multiple turbines can generate enough current within the on board regenerative ECU and power management system so that instantaneous voltage and power output has a significant impact to update said on board vehicle management systems and main ECU for range extension at highway speeds (high enough velocity to overcome internal resistance). In fact, it is preferred if the power output when the vehicle is travelling at highway speed is sufficient to fully power the vehicle management system and main ECU.

As an additional feature, the power supplied by the turbine module is used for providing power for vehicle propulsion through a vehicle inverter that may power one or both of the front and rear drive units in an electrically propelled vehicle. To provide vehicle architecture flexibility, a low voltage harness may be integrated into the vehicle (depending on configuration) for distribution of the power generated by the turbines. Additionally, the turbines can be used to provide power for battery cells within vehicle battery tray. Battery cells, managed through a vehicle battery management system, can actively be controlled by monitoring the voltage supplied by the turbines. Further, the turbine output can be utilized for providing power for on-board vehicle management systems, including overall parasitic overhead. These management systems cover and are not limited to audio, LED lighting, electronic dash sensors, active electronic stability control features including ride height and suspension monitoring systems, and other on-board vehicle systems.

In practice it is also possible to integrate individual turbine units into a multi-turbine array that can be laid out in substantially any desired configuration. The housing for such systems is created for multi directional integration where maximizing surface area of drag naturally taken off the front of a vehicle is at a maximum for power generation. This could involve laying out the individual turbines within one or more housing systems in a horizontal fashion. This includes corresponding gear boxes attached to turbine shafts, additional motor/generator attachments, and all other design features that can be incorporated for transmission of voltage or power. Similarly, the layout could be vertical or diagonal or even in a set of rows and columns or any other desired layout. Selection of the locations of the turbines can be facilitated by determining the locations on the vehicle responsible for the greatest amount of aerodynamic drag when moving at highway speeds and then placing the turbines at these locations. Also, selection of as many specific high drag locations as possible will facilitate provision of the maximum number of turbines and thus the maximum net power generation. Net power generation takes into consideration any residual drag occurring at locations where the turbines are placed. As a result, provision of additional turbines is effective only for locations where the drag is higher than the aerodynamic and electrical losses inherent in the placement and operation of the turbines.

Desirable locations for turbine placement, illustrated in FIG. 8, include the front of the vehicle radiator 86 or the lower exposed grille front of substantially any vehicle platform. At these locations drag is normally very high and the drag coefficient generally is at a peak which enables the turbines to be most productive relative to their incremental drag and thus highly effective at highway speeds. Strategic position in front of vehicle's radiator allows for an airflow design to add minimal drag (less than 0.009) to the overall drag coefficient as air is impacting a vehicle's radiator regardless of the added turbine generators. Optimally, the position of the lower edge and underside of the turbine casing is flush with the lower edge of the vehicle splash guard and diffusers for maintaining constant air flow while the vehicle is being driven at highway speeds. This provides a very effective integration of the turbines with the pre-existing aerodynamic shape of the vehicle, minimizing the incremental drag caused by the turbines. Other desirable locations for the turbines are on the front bumper 88 or bumper cover, on a forward-facing surface of an air deflector 89 and around the mounting area of the headlights 83 or other front facing surface 89. As an additional option, if the turbines are mounted on a front force absorber along a vehicle's front bumper (chassis location), it is possible for the turbines to be mounted and removed easily. According to this option, the turbines are not integrated with the vehicle structure, but rather are bolted or clipped into place. Because, in this configuration, it is not an integrated part of a vehicle's structure, but rather it's a removable product that can be mounted back on and off of a vehicle's front drive unit subassembly with ease, the unit can be offered as a free standing add on component. This enables use of the invention in a retrofit manner which can be added and removed without removal of subassembly, drive units, body panels, frame, suspension, and other secondary factors.

Initial design aerodynamic efficiency tests with concept electric vehicles were conducted resulting in identification of these locations as places where the greatest aerodynamic drag was created. Several design features resulted in improved results. Arrangement of multiple inlets in a honeycomb pattern as shown in FIG. 10 provided performance that was better than expected. This arrangement was better than other designs for placing a greater number of units within a given surface area and thus allowed for a high density of units on the surface. As an added benefit, the incremental aerodynamic drag introduced to the vehicle was lower than resulted from placement of a similar number of units on a surface area. Thus, with a honeycomb layout there was greater electrical generation and a smaller incremental aerodynamic drag.

In some situations, it might be advantageous to have a vehicle that does not exhibit some or any of the inlet openings. This might be the case for parked vehicles, where prevention of animals entering the vehicle could be desired. However, it might also be the case where a vehicle is moving at a particularly high rate of speed and the expected ratio of energy recovery through the turbine versus increased aerodynamic drag is not favorable to operation of the turbine. In this situation, closing the inlet will return the aerodynamic drag to its original level since that is preferable to maintaining the opening and creating a modest net energy loss. In an alternative embodiment, the opening can be regulated so that at excessive speeds where the inlet opening of the turbine creates too much drag for efficient operation of the turbine, the opening can be partially covered to decrease aerodynamic drag while allowing the turbine to generate sufficient electricity to make operation a net contributor to vehicle range. A concentrically closing aperture can be provided for this function. FIG. 10 shows a fully closed aperture 1001 and a partially closed aperture 1002.

Another reality in the design of motor vehicles is that the aerodynamic drag is not constant over a range of speeds. Different high-pressure areas come into play as vehicle speed changes. Thus, having the ability to open and close inlets to multiple turbines provides the opportunity to generate electricity efficiently at different speeds. When any particular high-pressure area does not have sufficient power generation capacity for a given vehicle speed (sufficient meaning more than enough to overcome the incremental drag) then that inlet can be covered. In this manner the range of the vehicle can be supplemented without suffering counterproductive consequences from the turbines. According to this embodiment of the invention, there can be selective control of one inlet separate from control of a second inlet, allowing for optimized overall system performance. Additionally, there are sometimes situations where the electrical system is not in need of additional regenerated power. This makes it feasible to close all (or most of) the inlets, thus providing the most aerodynamic vehicle profile. To accomplish closure of all inlets at once it is possible to provide a flap that can cover a group—up to all—of the inlets. Closing the flap can almost entirely return the vehicle's aerodynamic profile to the original design, and thus to a shape that does not suffer any aerodynamic degradation from the turbulence that would otherwise be created by the inlets. With this added feature, the vehicle can benefit from an addition operating option. When the vehicle is intentionally decelerating, it is possible to open the inlets for all of the channels and thus create aerodynamic crag to assist in slowing the vehicle. This feature can be implemented even when there is not a net power gain achieved by operation individual ones of the turbines. In a preferred implementation, there is a combination of the first mode of operation wherein selective opening and closing of individual inlets makes it is possible to engage only those channels that have a net power contribution, and also having a second mode of operation involving the opening of all of the channels, even those not providing a net contribution to power, whereby vehicle deceleration can be facilitated and electrical power can be derived because there is no need for a net power contribution when vehicle deceleration is desired.

To determine whether any particular area on the vehicle is suitable for generating net power at any particular vehicle speed, that is, generating more power than is lost due to incremental aerodynamic drag, the following equations can be used to calculate the force/power required to overcome a given amount of drag.

$$F = {C}_{D} \frac{1}{2} {ρ ( {V}_{T} - {V}_{P} )}^{3}$$

$${F}_{P} = ( . 045 ) \frac{1}{2} ( 1.195 \frac{kg}{{m}^{3}} ) {( 29.1 - 3.25 \frac{m}{s} )}^{3} = 464 N Required$$

$$When Power is Neutralized :$$

$$0 = {C}_{D} \frac{1}{2} ρ {A ( {V}_{T} - {V}_{P} )}^{2} - {F}_{p}$$

$$0 = ( . 0045 ) \frac{1}{2} ( 1.195 \frac{k g}{{m}^{3}} ) ( \text{.04} {m}^{2} ) {( {V}_{P} - 3.25 \frac{m}{s} )}^{2} - 464 N$$

$${V}_{P} = 23.98 \frac{m}{s} \approx 53 mph without the venturi within the channel$$

$$With venturi within channel = 23.98 \frac{m}{s} - 9.68 \frac{m}{s} = 14.3 \frac{m}{s} \approx 32 mph to overcome drag force$$

Then, it can be determined whether placement of the turbine at the identified location will be effective at any given target speed. By identifying the vehicle speed at which each identified location becomes available for incremental power generation, it can be determined whether to place a turbine there, and if so placed, whether and at what speeds to close the entrance to block airflow in order to return the surface to the original aerodynamic profile. Still further, it can be determined whether to partially open or close each inlet separately.

For determining the amount of pressure drop through the channel that can be created, and thus to determine the utility of an incremental channel in the system, it is helpful to determine the maximum achievable air flow rate. This can be calculated as follows:

$$Q = C \sqrt{\frac{2 ( Δ P )}{ρ}} \frac{{A}_{1}}{\sqrt{{( \frac{{A}_{1}}{{A}_{1}} )}^{2} - 1}}$$

$$Q = 0.98 \sqrt{\frac{2 ( 3,576.5 J )}{1.195 \frac{kg}{{m}^{3}}}} \frac{0.013 {m}^{2}}{\sqrt{{( \frac{0.013 {m}^{2}}{0.004 {m}^{2}} )}^{2} - 1}} = 0.262 \frac{{m}^{3}}{s}$$

Within each channel there will be a pressure drop and the following approach is employed to determine the pressure drop through the channel:

$${P}_{2} + \frac{1}{2} {ρ}_{2} {v}_{2}^{2} + {ρ}_{2} {gy}_{2} = {P}_{3} + \frac{1}{2} {ρ}_{3} {v}_{3}^{2} + {ρ}_{3} {gy}_{3}$$

$${P}_{2} + \frac{1}{2} ( 1.152 \frac{kg}{{m}^{3}} ) {( 82.66 \frac{m}{s} )}^{2} + ( 1.152 \frac{kg}{{m}^{3}} ) ( 9.81 \frac{m}{{s}^{2}} ) ( 0.038 m ) = 101 , 325 Pa + \frac{1}{2} ( 1.196 \frac{kg}{{m}^{3}} ) ( 29.1 \frac{m}{s} ) + ( 1.196 \frac{kg}{{m}^{3}} ) ( 9.81 \frac{m}{{s}^{2}} ) ( 0.064 m )$$

$${P}_{2} = 97 , 712 Pa or 97.7 kP$$

$${P}_{1} = 101 , 325 Pa \approx {P}_{3} so Δ P = 3 , 613 Pa$$

The drop in pressure within the channel (along with channel cross sectional area), will influence the velocity of air moving through the channel. This analysis is available to determine the venturi location and design. The change in air velocity is calculated as follows:

$${A}_{1} \times {V}_{1} = {A}_{2} \times {V}_{2}$$

$$( π ) {( 0.064 m )}^{2} ( 29.1 \frac{m}{s} ) = ( π ) {( 0.038 m )}^{2} ( {V}_{2} )$$

$${V}_{2} = 82.66 \frac{m}{s}$$

The changes is air velocity are correlated with changes in the air's kinetic energy. The resultant Change in kinetic energy is calculated as follows:

$$d K = \frac{1}{2} ρ dν or ( {v}_{2} - {v}_{1} )$$

$$\frac{1}{2} ( 1.195 \frac{k g}{{m}^{3}} ) ( 82.6 {6}^{2} - 29 . {1}^{2} \frac{m}{s} ) = 3 , 576.5 J = dK$$

While the foregoing discussion has addressed primarily the placement of the inlets to the air channels, the outlet placement is also a potential factor in improving system performance. Outlet location for each implementation can support obtaining maximum overall efficiency as well as “neutralization of drag” for net energy transfers. In automotive applications, the outlets have multiple possibilities, each with its own consequences. The outlet airflow can be released into a low-pressure area, and thus as a larger volume, into a vehicle's front wheel well. This provides for increased pressure release and decreased velocity release improving the characteristics of overall air flow through the system, with minimum impact of the aerodynamic drag of the vehicle. This outlet location favorably impacts overall vehicle drag coefficient by reducing friction inside the front wheel well as the “back pressure” effect causes front air dynamics to be pushed down the side of the vehicle (where it's intended by in the original vehicle design). The net result is that air flowing along the side of the vehicle is not caused to have undesirable velocity vectors directed toward the inside of a wheel/tire. Outlet airflow can alternatively be released to a vehicle's front air duct in front of the vehicle's wheel wells causing another pressure change to occur changing the air velocity vector's direction. This has a similar effect as releasing the airflow into the wheel well with the only significant differences occurring at outlet site and restrictions on outlet size due to the vehicle design. The outlet airflow could also be released to a vehicle's radiator inlet for increased cooling dynamics as well as reduced impact of air velocity for reducing frontal resultant force against the radiator. Impacts are equivalent to those above with an exception of air dynamics. Without a direct outlet to the exterior of the vehicle, air turbulence is relevant in finding ways for pressure to escape, causing a missed opportunity to decrease vehicle drag.

Dimensionally, there are limitations with automotive design that influence outlet placement and configuration, inlet placement and configuration, venturi dimensions and change in volume, and other constraints concerning the aerodynamics. For instance, angles between the vehicle axis and the impeller axis should preferably be limited to 34 degrees due to drag capture and added turbulence that is noticeable for air velocity loss before a venturi inlet. This impacts the positioning of the inlet as its angle towards such outlets are also desirably to such that no terns of more than 34 degrees are introduced to the airflow through the channel either before or after the venturi. This results in a desired limit of 68 degrees between the inlet orientation and the outlet orientation. In practice this relates to the dual turning constraint with respect to a vehicle's front radiator and wheel well positioning from frontal grill position (and or fog light application, frontal horizontal angle).

FIG. 9 illustrates placement of the blades 120 in a venturi portion 107 of channel 115. Selection of the dimensions of the channel and venturi can be calculated as described herein, and the location of inlet 105 and outlet 106 can be selected based on the total pressure differential between the two locations.

Channel constraints are also noticeable in constructing other potential variations inside vehicle platforms. These constraints can be seen through multi-variant venturi blade configurations, material constraints, motor constraints, and additional motor-controller dimension constraints. Inside the channel consists of direct aerodynamic relationships that impact every air velocity vector for every added surface area impact point (every strip of filament or material) that change the drag relationship within every portion of the channel. Such constraints can be analyzed as set forth above to determine the best dimensions and positioning of the components of the invention, including not only the air handling components but also the motor, controllers, wiring, and other components required for power to be transferred to desired locations within the vehicle.

In summary, exemplary systems embodying the invention have mass product potential due to the ability to help generate power for HVAC systems within commercial vehicles as well as electric vehicle platforms for longer range capabilities. Due to exemplary system size and light weight, users are able to integrate multiple variations within the same vehicle without compromising range due to weight and load increase. In other words, exemplary systems have been found to have a 42:1 ratio of mileage to weight added in an analytically modeled 200 kW lithium ion battery pack standard propulsion system (ETA range around 500-550 miles depending on commercial load). There is no such thing as free power, but exemplary systems have been found to offer desirable power “regeneration” based off a commercial vehicle's own drag within the front of the cab to recharge any electrical powered system. Hence, exemplary systems have a direct correlation to finding a solution to range anxiety in electric vehicle platforms without finding different battery pack solutions and for a fraction of the cost to produce.

In accordance with various exemplary embodiments, a benefit of the invention is the potential for integration and use on a commercial vehicle that makes a regenerating tunnel turbine unique. Unlike traditional turbines, exemplary systems are located within a wind funnel, maximizing air flow through multiple sets of blades with as much surface area as possible to capture high speed wind pressure. An exemplary unique 3-D printed funnel allows for easy accessibility on a commercial vehicle to allow for safety, noise degradation, and integration location flexibility. An exemplary dual blade setup is also a part of the specific design that enables the product to capture additional wind flow exiting the first set of receptive blades to maximize air impact (natural drag). Exemplary systems sit in a class of their own by really being one of the first few “regenerative power” products on electric or non-electric vehicle setup systems. Exemplary systems are able to be integrated on any vehicle (including electric semi trucks with low drag coefficient front ends) to help power all electrical systems within all vehicle classes.

In various exemplary embodiments, a regenerating tunnel turbine is a product that captures wind drag (mainly vehicles) and harnesses the power generated to transmit to multiple different applications (HVAC systems, chassis battery life, heat generators, etc.). Exemplary embodiments utilize receptive blades inside a “funnel” to capture as much air flow as possible and these blades turn a corresponding shaft that is regulated through a series of bearings for safety purposes. Through a dual shaft set up with additional gears it allows the system to generate beneficial amounts of power to a multitude of different applications. Exemplary embodiments may be utilized, for example on a semi-truck platform, to constantly generate power (especially at highway speeds) with zero (or nearly so) incremental power exertion.

It is an objective of the invention to improve overall efficiency of electric vehicles. In seeking to meet this objective, it has been determined that reliance of pressure, rather than wind speed, is beneficial. An interesting article shows that those working on the potential use of wind turbines for power generation in motor vehicles have focused primarily (or perhaps exclusively) on wind speed rather than wind pressure. See ASEE's Virtual Conference Jun. 22-26, 2020 Paper ID#31199, “Harvesting Drag Energy in Electric Automobiles” by Aman Luthra and Dr. Tom Lawrence. [available at peer.asee.org]

The importance of focusing on pressure rather than wind speed is has been identified as important because aerodynamic drag is primarily caused by high pressure accumulation at the front of the vehicle rather than friction. Also, low pressure behind a vehicle is a major contributor to aerodynamic drag.

Introduction of a system that addresses both of these contributors to aerodynamic drag is particularly beneficial. “Numerical Analysis and Visualization of Flow in Automobile Aerodynamics Development”, by R. Himeno and K. Fujitani in Computational Wind Engineering 1, 1993 state that the drag force of a passenger car consists of about 80% of pressure drag, 10% of drag caused by internal flow through an engine compartment and 10% of drag caused by roughness beneath the floor. This provides a good indication as to the benefit of selecting high pressure locations for implementation of the inventions air inlets into the turbine system.

One desirable application of the invention is in the conversion of a vehicle from reliance on an internal combustion engine to a fully electric drive system. In this situation, the vehicle has already been designed and the body panels are already set in their design. According to the invention, addition of a wind turbine system for electrical power generation can boost the vehicles power efficiency by extracting energy from high pressure areas exposed to oncoming relative airflow while driving. Selecting the locations where inlets will be provided is an aspect of the preferred embodiments of the invention. Best performance of the invention will be achieved when inlet locations are positioned at locations on the vehicle where highly compressed air exists when the vehicle is being driven. To find these locations, sensing of air pressure is a preferred approach. It has been determined best to sense the pressure at a plurality of forward facing locations on the vehicle while the vehicle is exposed to relative airflow at or above 25 mph or preferably at or above 45 mph. Driving the vehicle can generate the relative airflow, as can placing the vehicle in a controlled wind tunnel. Pressure sensing can be accomplished through use of, for instance, a pitot tube or a pressure sensor for detecting static pressure. The objective is to determine the potential energy present in high pressure air. Thus, the use of direct pressure sensors that are not influenced by air movement is preferred. Even more preferred is the use of pressure sensors that do not significantly interfere with airflow along the surface. Thus, a pressure sensor with a flat detection surface can be placed flat on the surface being measured so the pressure is measured, independent of the wind speed along the surface. Seeking locations where there is high pressure corresponds to locations where there is high potential energy. It is at these locations where the invention finds its greatest advantage. Another aspect of the implementations that provide the best performance involves selecting locations where lateral wind movement along the surface is relatively low compared to other areas. Thus, when multiple areas are determined to have comparable pressures at a given driving speed, preference for locating of the turbine inlet should go to the area having the lower airflow speed along the surface. This corresponds to areas where the invention can be implemented with the least interference with aerodynamic efficiency, and still provide the greatest electrical power generation. The use of a pitot tube to detect airflow along the surface is a preferable approach. Use of an array of pitot tubes makes characterization of airflow along the surface possible while using an array of pressure sensors provides an efficient mapping of high pressure areas.

Once it has been determined where the high pressure locations are on the vehicle and where airflow rates along the surface at a high pressure area is relatively low compared to lateral airflow rates at other high pressure areas, one or more of the high pressure areas with the lowest lateral airflow rates can be selected for installation of an inlet for the turbine generator.

To make a final determination as to whether the selected location is suitable for implementation of the invention, it is desirable to determine the impact of the addition of the turbine system to the aerodynamic drag of the vehicle. This can be done by determining the total power required to drive the vehicle at a speed of at least 25 mph, and preferably at least 45 mph before the modification, that is, before adding the inlet opening for the turbine. Then, the inlet for the turbine can be created at the proposed inlet location and the total power required for driving the vehicle at the same speed can be measured. With these two measurements, before and after adding the turbine inlet, it can be determined how much change in vehicle power requirements is caused by addition of the turbine system. For the most accurate assessment, the before and after tests should be based on addition of a fully functioning turbine system so that actual comparative information most closely resembles expected final results.

Then, to determine whether there is actually a benefit available from the addition of the turbine system, the power generating capabilities of the turbine system should be characterized as a function of driving the vehicle at a speed of at least 25 mph, and preferably at a speed of at least 45 mph. Characterizing the electrical generation performance of the turbine system at a plurality of speeds will provide an added benefit with respect to the possibility of enabling and disabling the system performance when it is not contributing to overall vehicle efficiency. Also, it will aid in determining whether to partially restrict the airflow through the turbine system when the vehicle drives at high speeds, above the speed when the turbine operates efficiently and safely.

Another aspect of the invention involves creating a characterization of the turbine's power generating capabilities as a function of the difference in air pressure between the systems inlet and outlet and also as a function of the cross sectional area of the inlet and outlet.

The total air flow through the generator over time will determine the power generation performance of the generator and for this reason, pressure difference and cross section will influence the amount of total air flow through the turbine system. The cross sectional area of the inlet can be selected based on the performance parameters of the turbine system, with a view to optimizing performance at a speed of at least 25 mph, and preferably at a speed of at least 45 mph.

Once it has been determined that the turbine system will generate more electrical power than is employed in operation of the turbine system, a decision can be made to go forward with installation of the turbine at the selected location. Then, at that location, sizing of the inlet opening can be determined based on the characterization of turbine performance at the design speed of at least 25 mph, and preferably of at least 45 mph. Select the location only if the power generated is greater than the power consumed.

Any method of determining that the power generated by the turbine exceeds the aerodynamic efficiency compromise caused by adding the venture turbine will meet the objective of the invention, but the wind tunnel testing described herein is considered to be the most reliable.

In an implementation of the invention that is a retrofit system for introduction when a gas powered vehicle is converted to electric propulsion, the forward facing portions of the gasoline powered vehicle that were previously employed for vehicle cooling through a radiator are no longer necessarily used for that purpose. It is possible to modify the forward facing portion of the vehicle to improve aerodynamic performance and additionally to capture the high potential energy created at forward facing portions of the vehicle even in spite of the best efforts to create a highly aerodynamic profile.

Determination of the coefficient of friction is easily accomplished using a rolling test. This consists of accelerating the vehicle to a given speed, perhaps 45 mph, and then coasting and measuring the time and/or distance of coasting including specific identification of how long it takes to reach pre-established distance markers along the coasting route. Because the vehicle will be the same vehicle used in a before and after test all other variables can be ignored with this simple test. There are numerous equations that can be employed to determine aerodynamic drag. However, due to the complexities of creating a simulation, it is desirable to use the vehicle for a real test. While a coasting test is easily implemented, it may be preferable to use a high quality wind tunnel to check for changes in the drag coefficient. The controlled environment within a wind tunnel will be more conducive to detecting the relatively small changes in drag coefficient that can be expected in the implementation of the invention. An advantage of the wind tunnel is that it provides significantly greater accuracy (compared to the simple rolling test) in determining the amount of power needed to keep the vehicle moving at a constant speed through the air. Thus, precise calculation of the drag coefficient is no necessary.

It is desirable to implement the invention without adding to the drag coefficient, and even reducing the drag coefficient. However, in an actual implementation of the invention it might be expected that changing the vehicle wind dynamics (modifying the vehicle's highly efficient shape) for implementation of the invention could have a slight incremental increase in overall vehicle drag coefficient.

However, when the vehicle being modified does not have a highly efficient aerodynamic shape, the invention can have a compound benefit, improving the aerodynamic drag and simultaneously generating electrical power. This is made possible by selecting surface areas on the vehicle (pre-modification) that are prone to high static pressure when being driven. This high static pressure corresponds to high potential energy. When the invention is employed, the high static pressure existing at a selected area for the wind turbine inlet actually experiences a somewhat reduced air pressure relative to the air pressure without having the air inlet present. This is a consequence of permitting air to flow through the surface upon which the wind was directly impacting prior to addition of the turbine inlet. Allowing air to enter the inlet provides a relief path for the high pressure air. This reduced air pressure actually reduces the pressure-related drag impeding the forward movement of the vehicle. By harnessing the potential energy at these locations where there is high potential energy and using this energy for generation of electrical power, there is no inherent inefficiency such as occurs when a wind turbine is located such that it intercepts rapidly moving airflow. By interrupting the rapid airflow, particularly airflow aligned with the length of the vehicle, kinetic energy is employed. Reliance on this kinetic energy inherently requires taking energy away from the forward motion of the vehicle, missing the opportunity identified herein for capturing potential energy for the power generation.

For conversion of a delivery van from an internal combustion engine to a fully electric drive, the front of the vehicle could be modified to create an optimized aerodynamic shape. This might involve modifications such as eliminating the radiator grill and streamlining the underside of the vehicle chassis. For any ICE vehicles, including delivery vans, there is a need for huge amounts of airflow through the radiator and the engine compartment for engine cooling. This airflow is counterproductive for several reasons, but most importantly because it is full of eddy currents, contributing to aerodynamic inefficiency. Another issue is that it tends to vent air under the vehicle, contributing to turbulence under the vehicle and adding to the aerodynamic drag of the vehicle. In a vehicle of this sort, placement of the outlet from the turbine system becomes very important. The rear of the vehicle provides an excellent location for the outlet because of the vacuum created behind the relatively flat rear surface of many delivery vehicles. Selection of a location for placement of the output can be implemented by placing an array of pressure sensors on the rear of the vehicle and then exposing the vehicle to relative airflow, either by driving the vehicle or by employing a well-controlled wind tunnel. Regardless of the method used, the objective is to find a location having low pressure such that, in combination with selecting a high pressure area for the inlet, as described above, creates a high pressure differential between inlet and outlet. Sizing of the outlet can be determined as a function of the airflow requirements of the turbine system.

While the description herein has explained that high pressure areas are to be employed for the inlet to the turbine system, it is also beneficial to avoid areas where there is rapid airflow along the surface. The existence of any rapid airflow indicates that aerodynamic performance has already imparted kinetic energy into this rapidly moving airflow. Any interruption of this airflow can negatively impact the vehicles overall aerodynamic efficiency. Thus, selecting a high pressure area having little or no lateral airflow along the surface provides the greatest advantage of capturing potential energy rather than kinetic energy. Again, capturing kinetic energy for driving the turbine system is not generally advantageous, and generally is detrimental to vehicle aerodynamics.

While the invention has been described herein with respect to several specific embodiments, as well as with respect to some of the optional applications of the invention, it is to be understood that this description is for the purpose of disclosing at least one manner of making and using the invention, including the best mode as known to the inventors. Not all manners of making and using the invention are specifically described with respect to the several embodiments set forth herein and the scope of the invention is not limited to the specific embodiments disclosed herein.

1. A method of improving the overall aerodynamic efficiency of a motor vehicle comprising the steps of:
a. sense the air pressure at a plurality of locations on forward facing surfaces of a particular vehicle when said vehicle is exposed to airflow of at least 25 MPH,
b. select an area of relatively higher pressure than other of said locations,
c. sense the air pressure at a plurality of locations having an average aft-facing orientation when said vehicle is exposed to airflow of at least 25 MPH,
d. select an area of relatively lower air pressure than other of said locations,
e. position a venturi-based turbine system having an inlet at said selected high pressure location and having an outlet at said selected low pressure location.

2. A method as claimed in claim 1 further comprising the steps of:
a. detecting the lateral airflow speed in the vicinity of said plurality of locations on forward facing surfaces, and
b. selecting said area of relatively higher pressure based, at least in part, on the detected lateral airflow speed.

3. A method as claimed in claim 2 wherein said step of selecting said area of relatively higher pressure is based on selecting an area having a lateral airflow speed lower than at other of said locations.

4. A method as claimed in claim 3 wherein said steps of sensing air pressure and airflow speed are conducted in a wind tunnel.

5. A method as claimed in claim 1 wherein airflow is at least 45 mph.

6. A method as claimed in claim 1 further comprising providing a variable cover for said inlet and reducing the inlet size as a function of the speed of the airflow to which the vehicle is exposed.

7. A method as claimed in claim 1 further comprising selecting a second area of relatively higher pressure and providing a second venturi-based turbine system having an inlet at said second area.

8. A method of improving the overall aerodynamic efficiency of a motor vehicle comprising the steps of:
a. sense the air pressure at a plurality of locations on forward facing surfaces of a particular vehicle when said vehicle is exposed to airflow of at least 25 MPH,
b. select an area of relatively higher pressure than other of said locations,
c. position a venturi-based turbine system having an inlet at said selected high pressure location.

9. A method as claimed in claim 8 further comprising the steps of:
a. detecting the lateral airflow speed in the vicinity of said plurality of locations on forward facing surfaces, and
b. selecting said area of relatively higher pressure based, at least in part, on the detected lateral airflow speed.

10. A method as claimed in claim 9 wherein said selecting said area of relatively higher pressure based, at least in part, on the detected lateral airflow speed being relatively lower than the lateral airflow speed at other of said locations.
